(19) United States
(12) Patent Application Publication
(10) Pub. No.: US 2017/0032430 A1
(43) Pub. Date: Feb. 2, 2017

(54) LIST-BASED ADVERTISEMENT SERVING

(71) Applicant: VIDEOLOGY, INC., Baltimore, MD (US)

(72) Inventors: Dennis Paul MICHALOPOULOS, Austin, TX (US); Kevin Coates HALEY, The Hills, TX (US); Scott Andrew Ferber, Bethesda, MD (US)

(21) Appl. No.: 15/264,759

(22) Filed: Sep. 14, 2016

Related U.S. Application Data
(63) Continuation of application No. 13/336,081, filed on Dec. 23, 2011, now abandoned.

(51) Int. Cl. G06Q 30/02

(52) U.S. Cl. CPC G06Q 30/0277; G06Q 30/0276; G06Q 30/0269

(57) ABSTRACT

A computer system and method for list-based advertisement serving are provided. In at least one embodiment, a computer system or method may comprise creating advertisement lists before runtime based on list generation data, wherein each of the advertisement lists is associated with a respective target audience definition. The computer system or method may also comprise allocating advertisements among the advertisement lists before runtime, based on the list generation data, to cause each advertisement list to include a prioritized sequence of advertisements.

### CROSS-REFERENCE TO RELATED APPLICATIONS

The present application is a continuation of U.S. patent application Ser. No. 13/336,081, filed Dec. 23, 2011, the content of which are incorporated herein in their entireties.

### TECHNICAL FIELD

The techniques described below relate to list-based advertisement serving using computer networks.

### BACKGROUND

Since the early 1990's, the number of people using the World Wide Web has grown at a substantial rate. As more users take advantage of the World Wide Web, higher volumes of traffic are generated over the internet. Because the benefits of commercializing the internet to take advantage of these higher traffic volumes can be tremendous, businesses increasingly seek ways to advertise their products or services on-line. These advertisements may appear, for example, in the form of leased advertising space (e.g., “banners”) on websites or other sources accessible by internet-enabled devices. Internet-enabled devices may include, for example, personal computers, smart phones, tablets, and digital television set-top boxes.

When a company advertises on a website, or any other medium, it may benefit from the volume of advertisements or impressions that it places on the website, the number of users that select or “click” on each advertisement, and the number of sales or other “conversions” that result from each display of an advertisement. Each instance that an advertisement is placed or served on a web page may be referred to as an “impression.” What advertisement is served on a web page may depend on a company's advertisement campaign.

To help satisfy advertisement campaign delivery requirements such as, for example, a desired number of clicks on an advertisement, the advertisement may be served for viewing by individuals or audiences based on various traits such as demographics, purchase history, or observed behavior. Behavioral targeting, for instance, uses information collected on an individual's web-browsing behavior to help select the advertisements to display to that individual. Such information may include, for example, internet searches or purchase history.

Some conventional advertisement serving techniques may utilize weighting schemes to select and serve advertisements in accordance with an advertisement campaign. Generally, weighting schemes include designating weights for advertisements such that higher-weighted advertisements are more likely to be served than lower-weighted advertisements. As an example, a weighting scheme may designate specific advertisements with higher weights based on specific campaign targeting requirements. Other conventional advertisement serving techniques may utilize an auction-based scheme, which selects ads based on revenue.

### SUMMARY

A computer system and method for list-based advertisement serving are provided. In at least one embodiment, a computer system or method may comprise creating advertisement lists before runtime based on list generation data, wherein each of the advertisement lists is associated with a respective target audience definition. The computer system or method may also comprise allocating advertisements among the advertisement lists before runtime, based on the list generation data, to cause each advertisement list to include a prioritized sequence of advertisements.

### BRIEF DESCRIPTION OF THE DRAWINGS

The accompanying drawings, which are incorporated in and constitute a part of this specification, illustrate various embodiments of the techniques, as described herein, and together with the description, serve to explain the principles of the techniques. In the drawings:

FIG. 1 is a block diagram illustrating a system that may be used with certain embodiments of the techniques;

FIG. 2 is a user interface that may be used with certain embodiments of the techniques;

FIG. 3 is a block diagram illustrating a system that may be used with certain embodiments of the techniques;

FIG. 4 is a flow diagram illustrating processes that may be used with certain embodiments of the techniques;

FIG. 5 is a flow diagram illustrating processes that may be used with certain embodiments of the techniques;

FIG. 6A illustrates advertisement lists and associated target groups in accordance with certain embodiments of the techniques;

FIG. 6B illustrates advertisement lists and associated target groups in accordance with certain embodiments of the techniques;

FIG. 6C illustrates advertisement lists and associated target groups in accordance with certain embodiments of the techniques;

FIG. 6D illustrates advertisement lists and associated target groups in accordance with certain embodiments of the techniques;

FIG. 6E illustrates advertisement lists and associated target groups in accordance with certain embodiments of the techniques; and

FIG. 7 is a flow diagram illustrating processes that may be used with certain embodiments of the techniques.

### DESCRIPTION OF THE EMBODIMENTS

Described below are techniques for list-based advertisement serving. In at least one embodiment of the techniques, deterministic processes may be used to select and sequence advertisements for users. Utilizing deterministic processes may provide for consistent advertisement serving decisions that better meet advertisement campaign delivery requirements.

In comparison to conventional advertisement-serving techniques, the embodiments of the techniques as described herein may leverage smart offline processes that not only hedge against failing to meet advertisement campaign delivery requirements but simultaneously maintain high advertiser satisfaction and maximum revenue. Determining the relative importance of an advertisement campaign using offline processes alleviates much of the work required to be performed by an advertisement server upon request for an advertisement. Thus, an advertisement server may be armed with smarter and more robust rules for determining which advertisements to serve for viewing by users.

Additionally, embodiments of the techniques avoid the need to perform an extensive series of operations each time an advertisement is to be served for viewing by the user. Instead, a majority of the online decision making required by the advertisement server is done the first time an advertisement is to be served. Serving advertisements for viewing by the user merely requires selecting the next advertisement in a sequence associated with the user. And, in some embodiments, advertisements are sequenced in such a way as to increase the probability of satisfying advertisement volume and targeting requirements.

Reference will now be made to accompanying figures. Wherever possible, the same reference numbers are used in the drawings and the following description to refer to the same or similar parts.

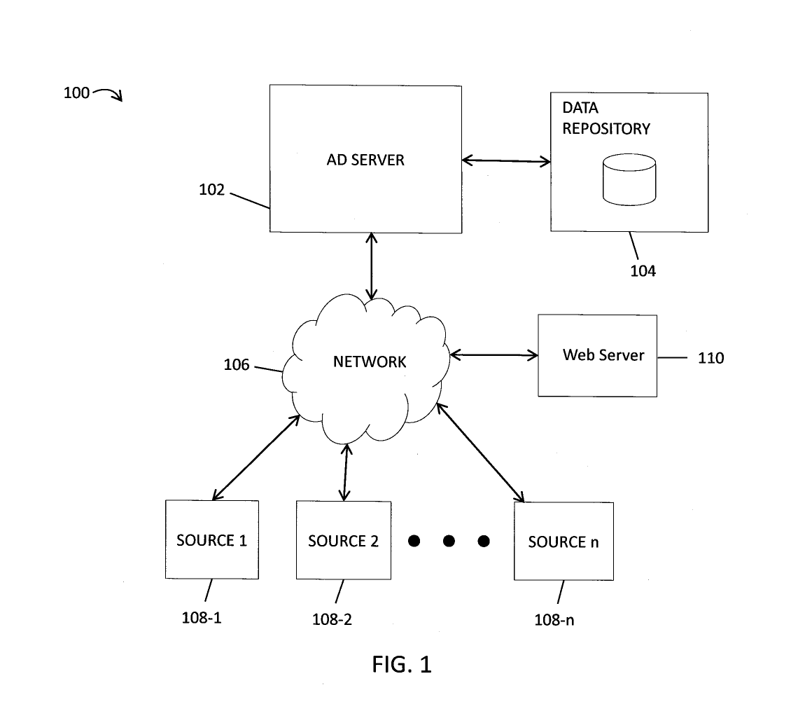

Referring now to FIG. 1, shown is a block diagram of a system that may be used in connection with performing techniques described herein. System 100 may include ad server 102, data repository 104, viewer sources 108-1 through 108-n, and web server 110. Ad server 102, viewer sources 108-1 through 108-n, and web server 110 may communicate through network 106. Network 106 may be any one or more of a variety of networks or other types of communication connections as known to those skilled in the art. Network 106 may include a network connection, bus, or other type of data link, such as a hardwire or other connection known in the art. For example, network 106 may be the interne, an intranet network, a local area network, or other wireless or other hardwired connection or connections by which viewer sources 108-1 through 108-n, ad server 102, and web server 110 may communicate.

Ad server 102 may be, include, or be part of a technology and/or service that provides advertisements to viewer sources 108-1 through 108-n. In various embodiments, ad server 102 may be, for example, a general purpose computer, a server, a mainframe computer, and/or a computer with a specific purpose of serving advertisements. For example, ad server 102 may be a computer server that stores advertisements and, based on campaign requirements, delivers advertisements to be viewed on a computer. Ad server 102 may also perform various data gathering and data analysis tasks such as, for example, counting the number of impressions or clicks for an ad campaign.

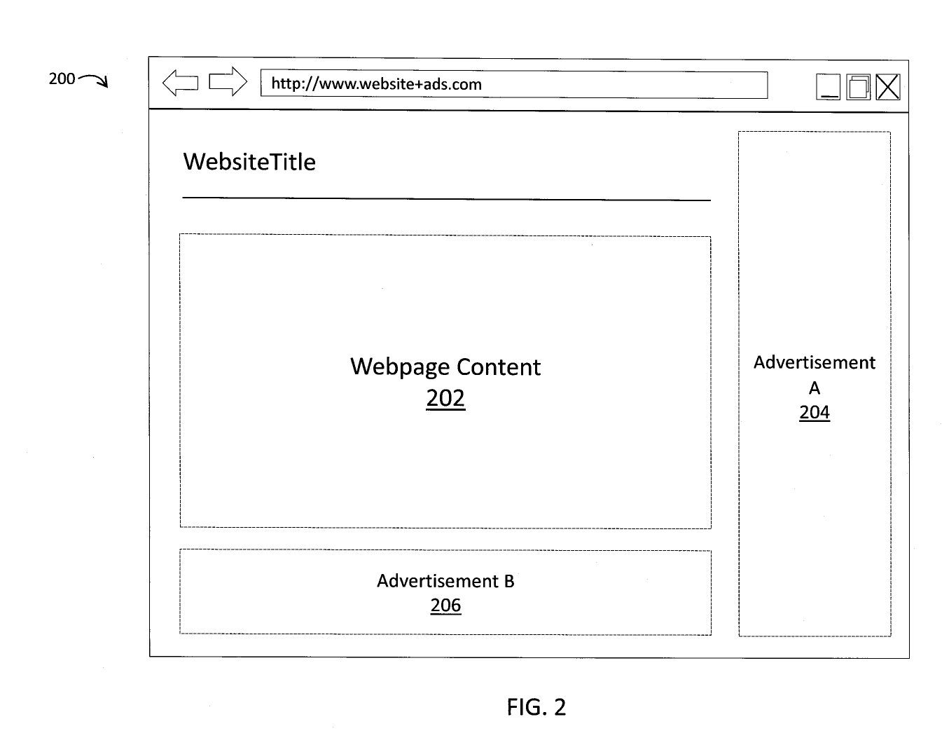

Web server 110 may be, include, or be part of a technology and service that provides webpages or other content to requesting sources, for example, via graphical user interfaces. Webpages may be provided as HyperText Markup Language (HTML) documents or any other type of data that may be used to create webpages. Webpages may include images, videos, text, advertisements, or other content that is suitable for the World Wide Web and can be accessed through a web browser on a viewer source. For example, referring to FIG. 2, shown is a webpage via web browser 200. As shown, the webpage includes webpage content 202, advertisement A 204, and advertisement B 206.

Referring again to FIG. 1, in certain embodiments, web server 110 may be owned or operated by a content provider or domain name controller and may store webpages and other internet resources associated with one or more domain names. As with ad server 102, web server 110 may include a processor, storage, and memory. The memory may include one or more web server programs for receiving and responding to, for example, HyperText Transfer Protocol (HTTP) requests and one or more server-side scripts for providing dynamic webpages. Each such program, for example, may be loaded from storage.

Viewer sources 108-1 through 108-n may be, include, or be part of any entity capable of requesting and presenting advertisements to one or more users. For example, viewer source 108-1 may be a particular website. Viewer source 108-2 may consist of one or more types of devices, or a subset of such devices, such as, for example, television set-top boxes, tablet computers, or smart phones of a particular brand and model. Other viewer sources may include, for example, a particular application, specific web pages within one or more website, and advertisement units within one or more websites (e.g., advertisement banners).

In some embodiments, a user may be uniquely identifiable. For example, a user using a personal computer with internet access may be uniquely identified by an Internet Protocol (IP) address associated with the personal computer or by an interne cookie stored on the personal computer. As another example, a user may be uniquely identified by an International Mobile Equipment Identity number of a mobile device associated with the user. As yet another example, a user may be uniquely identified by a unique user identifier associated with an application, which may be, for instance, assigned or chosen by a user during application installation or service enrollment such as a username and password combination.

Data repository 104, which may be communicatively connected to ad server 102, may include one or more files and/or databases that store information that is accessed, used, and/or managed by ad server 102. Data repository 104 may include, for example, information associated with sources 108 that is gathered by ad server 102 (e.g., advertisement impressions and clicks), users, advertisement campaign data, advertisements, and lists of advertisements. The same or similar data may also be stored in ad server 102 or one or more other data repositories.

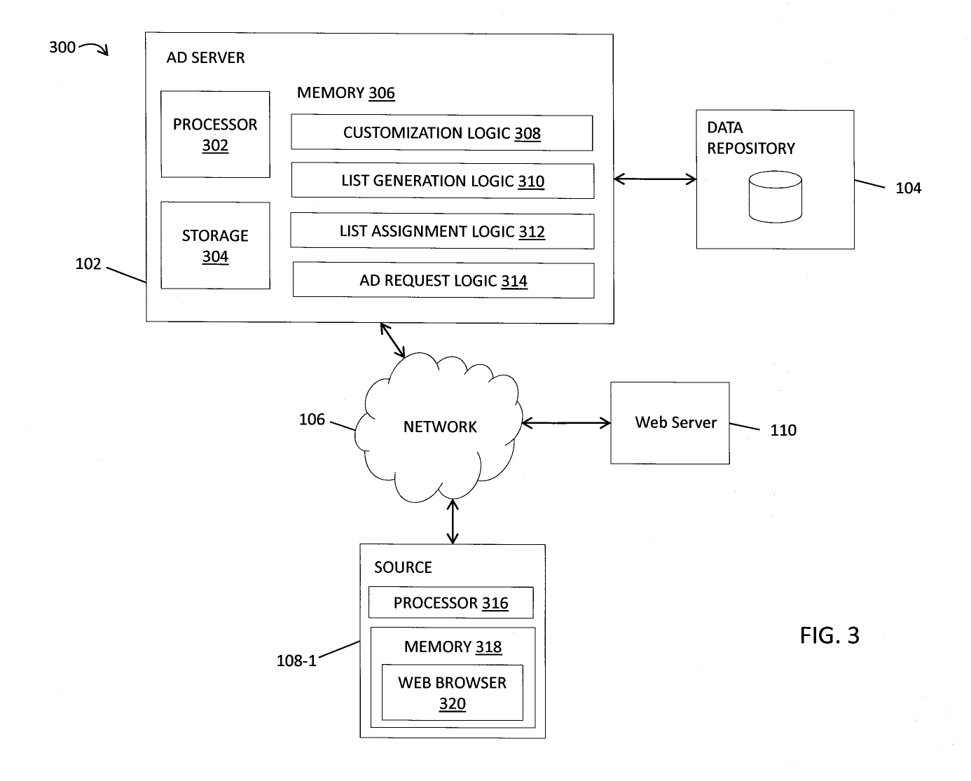

Referring now to FIG. 3, shown is a block diagram illustrating components that may be used with a specific embodiment of the techniques. In this embodiment, ad server 102 may include processor 302, storage 304, memory 306, and input/output (I/O) devices (not shown).

Processor 302 may be one or more known processing devices such as, for example, a microprocessor, a microcontroller, an application-specific integrated circuit (ASIC), a field programmable gate array (FPGA) or other type of processing circuitry, as well as portions or combinations of such circuitry elements. Storage 304 may include volatile or non-volatile, magnetic, semiconductor, tape, optical, removable, non-removable, or other types of storage or computer-readable media.

In some embodiments, memory 306 may include software loaded from storage 304 and executed by processor 302 to perform one or more processes consistent with the techniques. In a particular embodiment, memory 306 may include customization logic 308, list generation logic 310, list assignment logic 312, and ad request logic 314. Memory 306 may also include other programs and logic that perform other processes such as, for example, programs that provide communication support. Memory 306 may also be configured with an operating system (not shown) that performs functions well known in the art when executed.

Memory 306 may be viewed as an example of what is more generally referred to herein as a “computer program product” having executable computer program code in accordance with discussed techniques embodied therein such as, for example, list generation logic 310. Such memories may comprise electronic memories such as random access memory (RAM), read-only memory (ROM) or other types of memory, in any combination. One skilled in the art would be readily able to implement such computer program code given the teachings provided herein. Other examples of computer program products embodying aspects of the invention may include, for example, optical or magnetic disks.

In the embodiment of FIG. 3, source 108-1 may be, for example, a device such as a personal computer, smart phone, or set-top box that also includes a processor 316 and memory 318, as well as web browser 320. Web browser 320 may be a software application stored in memory 318 and executed by processor 316 for the purpose of retrieving and presenting information on the World Wide Web. In some embodiments the information may be presented as part of a webpage such as webpage 200 of FIG. 2. In certain embodiments, source 108-1 may exchange data with ad server 102 and/or other servers, such as web server 110, for the purpose of displaying webpages such as via web browser 320. For example, a user of source 108-1 may request a webpage by entering a Uniform Resource Locator (URL) into web browser 320. Web server 110 or ad server 102 may respond to the request by sending the content of the requested webpage to source 108-1 to be displayed via web browser 320. In an embodiment in which web server 110 responds to the webpage request, the webpage may contain one or more advertisements requested by web server 110 from ad server 102.

It should be noted that the particular examples of the hardware and software that may be included in systems 100 and 300 are described herein in more detail, and may vary with each particular embodiment. For example, systems in accordance with the techniques such as systems 100 and 300 may comprise more than one of each of the components specifically shown in FIGS. 1 and 3. Thus, it is to be appreciated that a given embodiment of systems 100 and 300 may include multiple instances of ad server 102, data repository 104, and web server 110, and in regards to system 300, multiple instances of processor 302 and 316, memory 306 and 318, storage 304, customization logic 308, list generation logic 310, list assignment logic 312, ad request logic 314, and web browser 320, although only single instances of such components are shown in simplified system diagrams 100 and 300 for clarity of illustration.

Conventional components of a type known to those skilled in the art may instead or also be incorporated into systems 100 and 300. Thus, it should be understood that the techniques should not be limited to the embodiments described and illustrated herein. For example, the techniques do not require the use of a web server or web browser as illustrated in systems 100 and 300. For instance, in some embodiments, non-web-based platforms may be used such as, for example, linear feed television that allows users to be targeted directly through a television set-top box; non-Internet Protocol (IP) based delivery mechanisms such as cellular networks (e.g., GSM, CDMA, FDMA, TDMA, SMS, MMS, etc.); applications for mobile devices (e.g., APPLE IOS based mobile applications for the !PHONE and IPAD, ANDROID operating system based mobile applications for numerous device manufacturers), televisions, IP- and non-IP-connected devices, smart boxes, kiosks, terminals; or any other device or delivery mechanism that supports the delivery of advertisements.

It should also be noted that in some embodiments, functionalities and data provided by the components shown in systems 100 and 300 may be provided by other components shown or not shown in systems 100 and 300. For example, ad server 102 may additionally provide the same or similar functionalities as provided by web server 110.

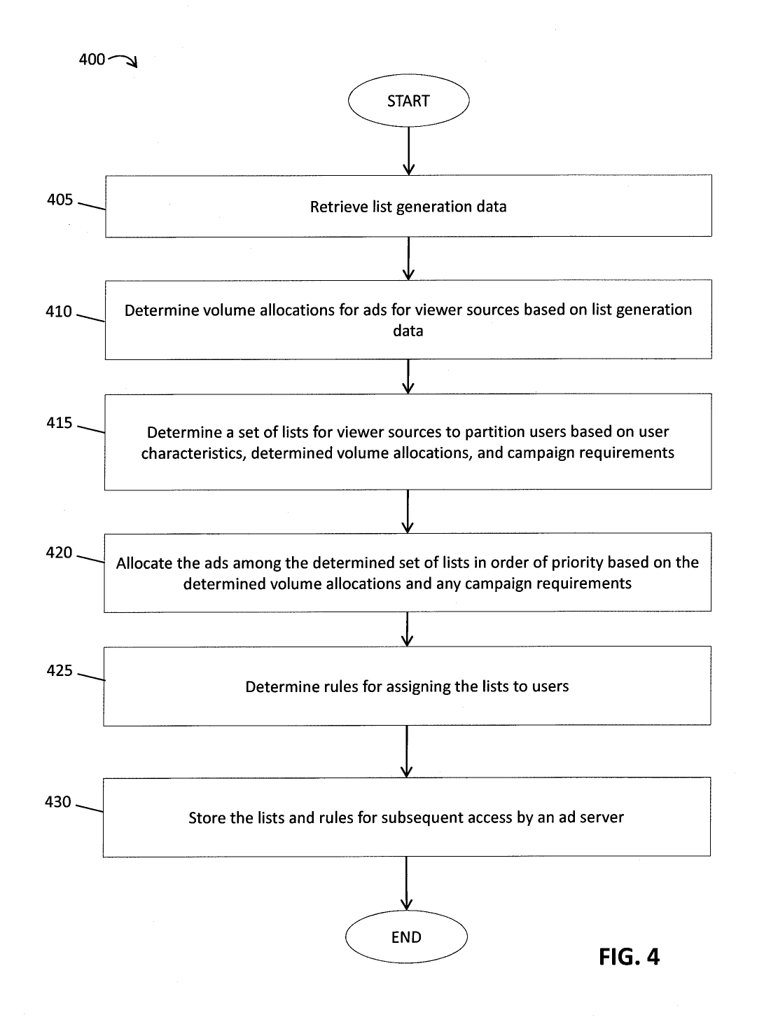

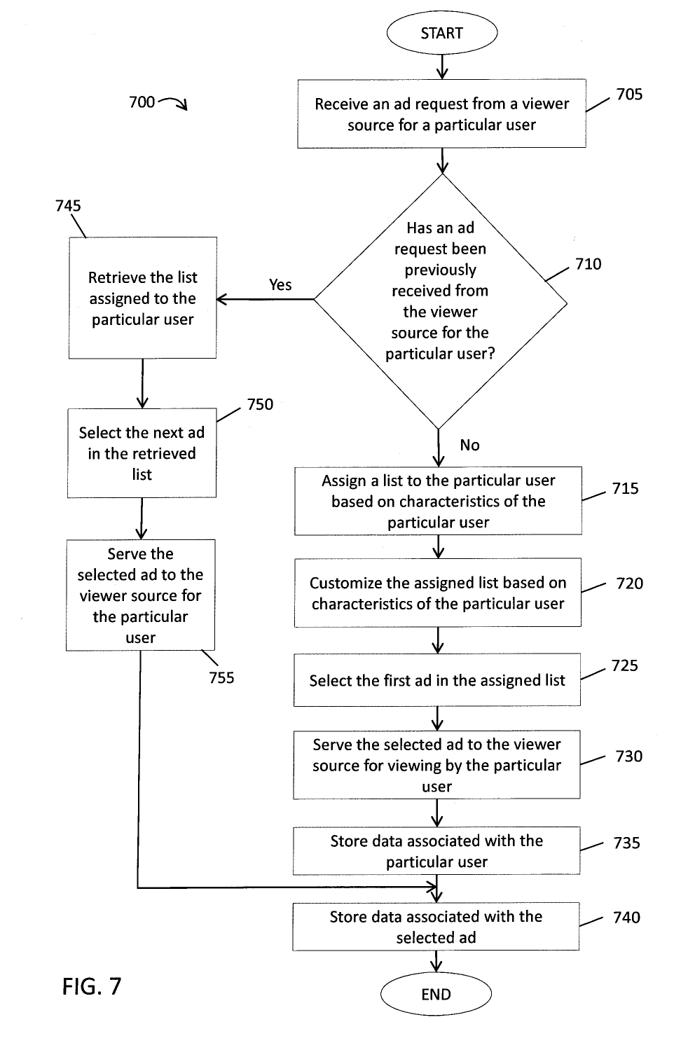

Referring now to FIG. 4, in accordance with an embodiment of the techniques, shown is flow diagram 400 illustrating processes that may be performed by, for example, executing list generation logic 310. The processes illustrated in flow diagram 400 may be performed at any time. For example, in certain embodiments, the processes may be performed offline (i.e., pre-runtime) in order to power subsequent online (i.e., runtime) processes such as, for example, the processes as illustrated in flow diagram 700 of FIG. 7 described below. In a specific embodiment, the processes may be initiated, for example, in accordance with a predetermined time interval (e.g., every morning), upon the occurrence of a triggering event, or manually.

In accordance with an embodiment of the techniques, the processes illustrated in flow diagram 400 may result in one or more lists, or sequences of advertisements. Generally, a list may be a collection of advertisements that may be created and assigned to a user upon the initial identification of the user as part of an advertisement request sent from a viewer source.

In step 405, list generation data may be retrieved from one or more storage locations such as, for example, internal storage 304, or data repository 104. List generation data may include, for example, current and historical advertisement campaign data and historical viewer source data. In some embodiments, list generation data may instead or also include data derived from current and historical advertisement campaign data and historical viewer source data. Current advertisement campaign data may refer to parameters for existing advertisement campaigns such as, for example, the remaining volume of advertisement impressions required to be served for the remainder of an advertisement campaign life, characteristics of users for whom advertisements are to be served, performance metrics (e.g., click-through rates), and progress data associated with advertiser's targeting goals. Historical advertisement campaign data may include the same or similar data as current advertisement campaign data except that historical advertisement campaign data is associated with advertisement campaigns that have ended. Historical viewer source data may include any data associated with an advertisement audience group that may be leveraged to help determine lists and list composition. For example, historical viewer source data may include observable characteristics of users and viewer sources. In some cases, for instance, such data may reveal the demographics of a particular advertisement audience group. Additional examples of list generation data may include geographic data, temporal data, and other contextual data.

In step 410, for each viewer source, the list generation data retrieved in step 405 may be used to determine which advertisements, and in what volumes, will be used to satisfy advertisement requests from each viewer source. In some embodiments, the list generation data may be aggregated and/or manipulated to facilitate determining advertisements and volumes in step 410. For example, for a specific viewer source, list generation data may be used to determine that 10,000 impressions of advertisement AD₁ and 20,000 impressions of advertisement AD₁ are to be served, and for another specific viewer source, 5,000 impressions of AD₂ and 10,000 impressions of advertisement AD₃ are to be served.

In step 415, one or more lists may be created for viewer sources based on, for example, observable or known audience group characteristics, campaign requirements, and/or advertisement volume allocations. In some embodiments, lists are created such that there exists at least one list for which any user assigned the list satisfies certain advertisement campaign requirements. Thus, in some embodiments, users assigned to a particular list may not share completely identical characteristics but may instead share a subset of characteristics that make the users eligible for the list.

Advertisements may be allocated to the lists in step 420 based on, for example, campaign requirements and/or advertisement volume allocations. In some embodiments, each advertisement can be allocated to at least one list such that certain advertisement campaign requirements are satisfied. As a specific example, advertisement AD₁ from above may have an associated restrictive campaign targeting requirement such that AD₁ can only be served for viewing by users who reside in a specific geographical region, and advertisement AD₂ does not have any restrictive campaign targeting requirements. In this example, at least two lists may be created based on the campaign targeting requirements: list L₁, which may have advertisements AD₁ and AD₂ allocated to it, and list L₂, which may have advertisement AD₂ allocated to it. List L₁ may then be served for viewing by users who reside in the specific geographical region to which AD₁ can be served, and list L₂ may be served without restriction.

In some embodiments, advertisements may be allocated to a list in step 420 in order of priority. For example, high priority, low volume advertisements may be allocated to a list before other advertisements. Prioritizing advertisement allocation may help satisfy campaign requirements.

In certain embodiments, to ensure that a user is assigned to only one list upon an advertisement request from a viewer source and/or user, rules may be used to resolve viewer list eligibility conflicts. Therefore, in step 425, rules may be automatically or manually determined for assigning lists to users. In at least one embodiment, rules may consider, for example, user characteristics to determine which one of at least two lists to assign a user. In another example embodiment, geographical location may be considered instead or in addition to other factors. As a specific example, a user who resides in the specific geographical region corresponding to advertisement AD₁ may be assigned to both lists L₁ and L₂. To avoid this scenario, a rule may establish that users who reside in the specific geographical region corresponding to advertisement AD₁ may only be assigned to list L₁.

Once the lists and rules are created in steps 405 through 425, the lists and rules may be stored for subsequent access by ad server 102 in step 430. In some embodiments, the lists and rules may be stored together in data repository 104, storage 204, or in any other storage medium accessible to ad server 102. In an alternative embodiment, lists and rules may be stored separately such that, for example, the lists are stored in data repository 104 and the rules are stored in storage 204.

In some embodiments, the techniques described above may result in lists that correspond to, for example, the same or similar target audience groups. For example, lists in the initial set of lists as created in step 415 may be defined in a way that result in two or more lists that, for example, are entirely redundant or cover the same audience groups.

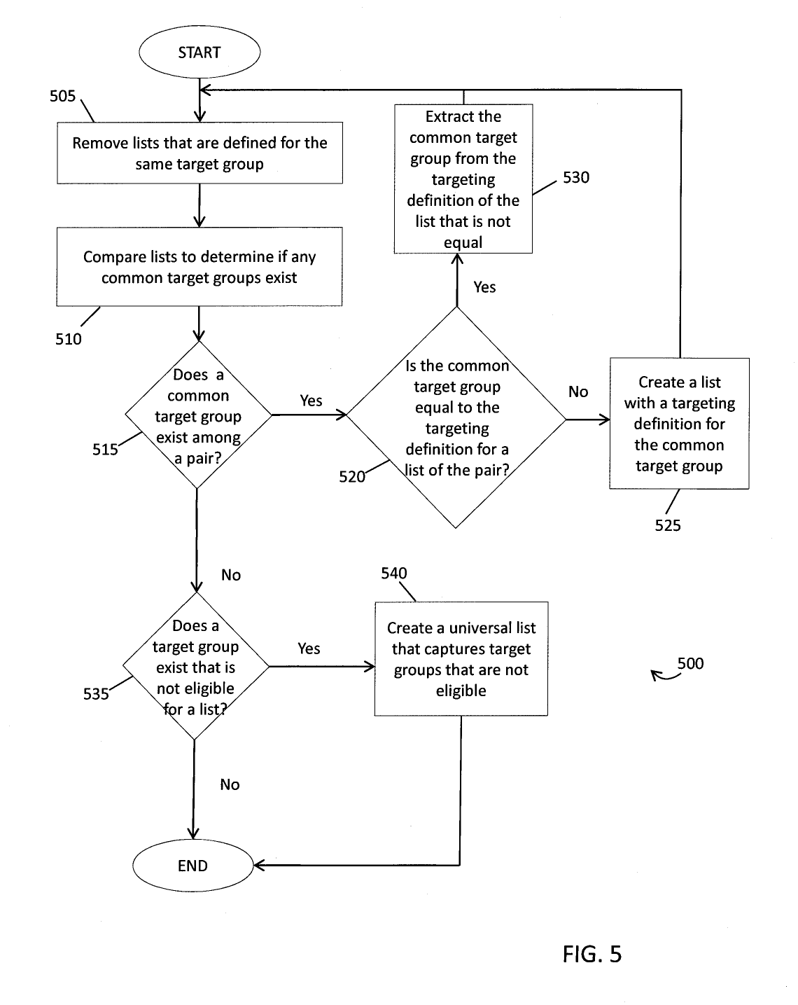

Referring now to FIG. 5, in accordance with an embodiment of the techniques, shown is flow diagram 500 illustrating processes that may be performed to refine the lists created in the processes illustrated in flow diagram 400. In some embodiments, the processes illustrated in flow diagram 500 may be performed by, for example, executing list refinement logic 310. It should be noted that the processes illustrated in flow diagram 500 may be performed at any time after the lists are created such as, for example, after step 415 of flow diagram 400.

In step 505, redundant lists are removed from the set of created lists. Stated differently, if any lists exist that are defined for the same target audience group, the redundant lists are removed. In step 510, the remaining lists are compared with one another. Based on the comparison, in step 515 it is determined whether a common target audience group exists among a pair of lists. In step 520, for each list pair with a common target audience group, a determination is made as to whether the common target audience group is equal to the targeting definition of either list of the pair. If it is determined in step 520 that the common audience target group is not equal to the targeting definition of either list, a new list is created in step 525 with a targeting definition that includes the common audience target group. The process may then return to step 505. If it is determined in step 520 that the common audience target group is equal to the audience target definition of either list, the common audience target group is extracted from the targeting definition of the list that is not equal to the common audience target group in step 530. The process may then return to step 505.

In step 535, it is determined whether target audience groups exist that are not eligible for a list. If any such target audience group exists, a universal list is created at step 540 that captures these target audience groups. Following completion of step 535, the processes illustrated in FIG. 5 terminate with a newly defined set of lists.

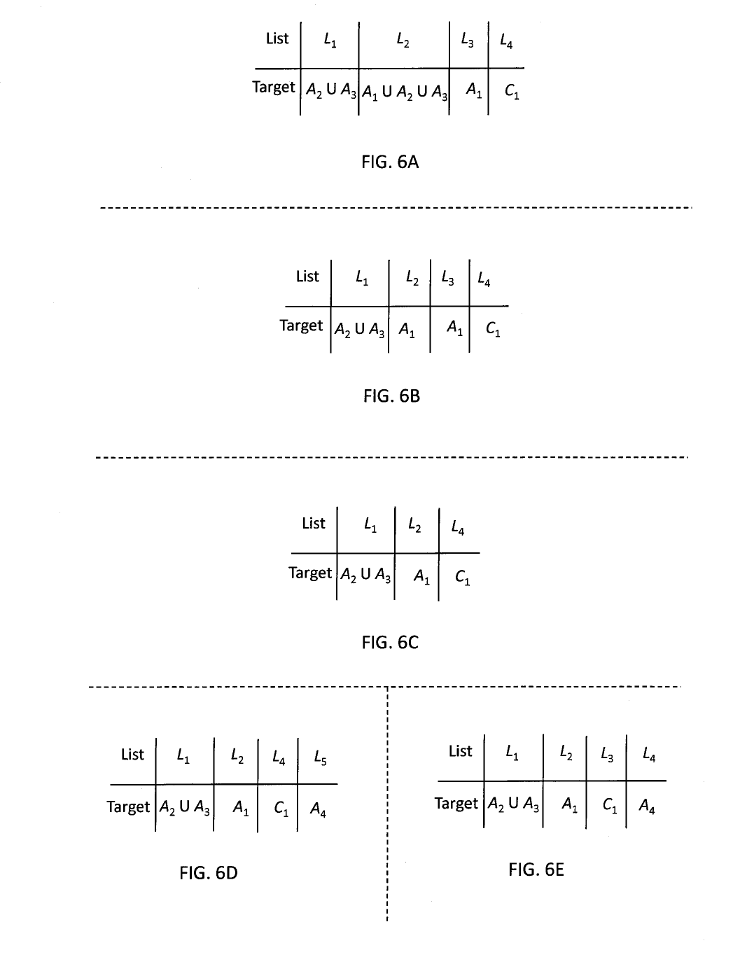

As a specific example of the processes illustrated in FIG. 5, consider FIGS. 6A through 6D. FIG. 6A depicts a list set created, for example, at step 415 of processes 400. As shown, list L₁ has a targeting definition that includes the union of target audience groups A₂ and A₃; list L₂ has a targeting definition that includes the union of target audience groups A₁, A₂, and A₃; list L₃ has a targeting definition that includes audience target group A₁; and list L₄ has a targeting definition that includes target audience group CI.

No duplicate lists exists in the initial lists illustrated in FIG. 6A. Proceeding to step 510, lists L₁, L₂, L₃, and L₄ are compared with one another. In step 515 a determination can be made that a common target audience group, A₂ U A₃, exists among lists L₁ and L₂. In step 520 a determination can be made that the common target audience group is equal to the target audience group that defines the targeting definition of list L₁. Thus, in step 530, the common target audience group may be extracted from the targeting definition of list L₂—the list with a targeting definition that is not equal to the common target audience group. As a result, list L₂ now has a targeting definition that includes target audience group A₁. The targeting definition of list L₁ remains unchanged. The resulting list set is illustrated in FIG. 6B.

Returning to step 505, an examination of the list set as illustrated in FIG. 6B reveals duplicate lists L₂ and L₃. Thus, list L₃ may be removed (or, e.g., L₂ could be removed instead), yielding the list set illustrated in FIG. 6C.

Proceeding again to step 510, lists L₁, L₂, and L₄ depicted in FIG. 6C are compared with one another. At step 515, a determination can be made that no common target audience groups can be derived from the lists. At step 535, assuming that target audience groups A₁, A₂, A₃ and C₁ do not comprise the entire audience universe, a determination may be made that a universal list that captures all audience groups not eligible for a list should be created. Therefore, as shown in FIG. 6D, new list L₅ may be created that has a targeting definition that includes all audience groups not included in A₂ U A₃, A₁, OR C₁, which is denoted as A₄ in FIG. 6D. If the lists are renumbered, the list set illustrated in FIG. 6E results.

Referring again to FIG. 6A, if the initial list set of FIG. 6A is slightly modified to include target audience group A₅ in L₁ (i.e., list L₁ would target A₂ U A₃ U A₅) step 520 would result in a determination that the common target audience group is not equal to the targeting definition of either L₁ or L₂. In this scenario, in step 525, a new list is created with a targeting definition that includes A₂ U A₃—the common target audience group. Repeating steps 505 through 530 one or more times would then result in the extraction of common target audience group A₂ U A₃ from both L₁ and L₂.

Referring now to FIG. 7, in accordance with an embodiment of the techniques, flow diagram 700 illustrates processes that may be performed to serve advertisements to viewer sources. In some embodiments, process 700 may be performed by ad request logic 314 in combination with list generation logic 310 and/or list assignment logic 312. It should also be noted that the processes illustrated in flow diagram 700 may occur at runtime, in certain embodiments.

In step 705, an advertisement request may be received at an ad server from a viewer source for a particular user. At step 710, it may be determined whether a request was previously received from the viewer source for the particular user. If a request was not previously received from the viewer source for the particular user, in step 715 a list such as a list created in accordance with processes 400 and/or 500 may be assigned to the particular user. As noted above, the lists may be retrieved from, for example, a data repository.

Determining whether a request was previously received from a viewer source for a particular user may be accomplished, for example, by examining a unique be, for example, an IP address associated with a personal computer or information stored as part of a cookie on a user's computer. Or, alternatively, a unique identifier may be, for example, a username and password combination allowing a user to access an application or service. It should be noted that in some embodiments a list may be assigned to a user irrespective of the viewer source. In these embodiments, the user may still need to be uniquely identifiable. Thus, for example, a user may be assigned a list and advertisements allocated to that list may be served to many different viewer sources for the user so long as the user can be uniquely identified, as described above.

Which list to assign a user may be determined by list assignment logic 312. In some embodiments, a list is assigned to a user based on the user's known or observable characteristics. For example, one or more characteristics such as a user's age, gender, race, geographical location, personal interest, and/or job may be used to help determine which list to assign a user. As a specific example, in some embodiments, a list created in accordance with the processes as illustrated in flow diagrams 400 and 500, and having a targeting definition that includes males between the ages of 21 and 35, may be assigned to only males between the ages of 21 and 35. In similar embodiments, a list having a targeting definition that includes all individuals who live in a particular geographical location may be assigned to only individuals who live in the particular geographical location. If the two lists described above are included in a list set, males between the age of 21 and 35 who live in the particular geographical location may be assigned only one of the two lists in accordance with the rules determined in step 425 of flow diagram 400.

In some embodiments, list assignment logic 312 may utilize various models that take user data as input and outputs data that may be used to help determine a list to be assigned to a user. For example, a logistic regression model may be used that analyzes user data to determine the probability that a user is of a particular category of users such as, for example, coffee buyers, online shoppers, and moviegoers. As a specific example, the logistic regression model may determine that a particular user is likely a coffee buyer based on user data associated with the particular user. The fact that the particular user is likely a coffee buyer may then be used to help determine an appropriate list to be assigned to the particular user.

In step 720, using customization logic 308, assigned lists may be customized based on characteristics of the particular user to which the list is being assigned. For example, customization may include stipulating a maximum number of times each advertisement appears, modifying the order in which each advertisement is served for viewing by a user, and changing any other list features that are deemed appropriated for a user. For example, two users assigned the same list based on a subset of characteristics may be served advertisements for viewing included in the assigned list in a different order due to list customization based on a separate subset of characteristics.

Once a list is assigned to a user, in step 725 the first advertisement in the list may be selected, and in step 730, the selected advertisement may be served to the viewer source. For example, in some embodiments, the advertisement may be served and then rendered on a website viewed via a web browser such as in advertisement banner 204 of FIG. 2. In some embodiments, advertisements are served from the ad server 102 directly to a viewer source via network 106. In other embodiments, advertisements may be served using an intermediary server via network 106.

In step 735, data associating the list with the particular user may be stored for future reference in, for example, a data repository. Data identifying which advertisement of the list is selected and rendered may also be stored in step 740.

If it is determined that an advertisement request was previously received from the viewer source for the particular user in step 710, in step 745 the list assigned to the particular user is retrieved, for example, from a data repository. A list may be retrieved, for example, based on a unique identifier as described above. Once retrieved, based on the data stored in step 740, the next advertisement in the list that has not been served may be selected in step 750 and, in step 755, served to the viewer source. Data identifying the next advertisement to be selected and rendered may be stored in step 740.

The foregoing description of the techniques, along with associated embodiments, has been presented for purposes of illustration only. It is not exhaustive and does not limit the techniques to the precise form disclosed. Those skilled in the art will appreciate from the foregoing description that modifications and variations are possible in light of the above teachings or may be acquired from practicing the techniques. For example, the steps described need not be performed in the same sequence discussed or with the same degree of separation. Likewise, various steps may be omitted, repeated, or combined, as necessary, to achieve the same or similar objectives. Accordingly, the spirit and scope of the techniques described herein should be limited only by the following claims.

What is claimed:

1. A method, implemented on a machine having at least one processor, storage, and a communication platform connected to a network for providing online advertisements, the method comprising:
receiving an online request for an advertisement in connection with a user;
creating a plurality of advertisement lists, each of which is associated with one or more audience groups and includes a plurality of advertisements arranged in a first order;
determining, based on a first characteristic of the user, at least one audience group to which the user belongs;
selecting an optimized advertisement from the plurality of advertisement lists by
determining, from the plurality of advertisement lists, an advertisement list associated with the at least one audience group to which the user belongs,
customizing the first order of the plurality of advertisements in the advertisement list based on a second characteristic of the user to generate a customized advertisement list for the user with the plurality of advertisements therein arranged in a second order, and,
determining the optimized advertisement by selecting a first advertisement in the customized advertisement list according to the second order; and
providing the optimized advertisement in response to the online request.

2. The method of claim 1, further comprising
recording the customized advertisement list with information indicating that the first advertisement has been served so that remaining advertisements in the customized advertisement list in the second order are to be served in response to subsequent online requests.

3. The method of claim 1, wherein the plurality of advertisement lists are created based on:
characteristics of users to whom advertisements in the plurality of advertisement lists were previously presented;
reactions of the users exhibited to the previous presentations of the advertisements in the plurality of advertisement lists; and
which advertisements have been presented to which users.

4. The method of claim 1, wherein the first order of advertisements in an advertisement list is determined based on at least one of: a volume associated with each advertisement in the advertisement list and a priority associated with the advertisement.

5. The method of claim 1, wherein the step of determining an advertisement list comprises:
obtaining a set of candidate advertisement lists based on the at least one audience group; and
determining, from the set of candidate advertisement lists, the advertisement list associated with the at least one audience group based on at least one characteristic of the user.

6. The method of claim 5, wherein determining the advertisement list from the set of candidate advertisement lists is further based on predetermined conflict resolution rules.

7. The method of claim 1, further comprising refining the plurality of advertisement lists based on information related to their respective audience groups.

8. The method of claim 7, wherein the step of refining comprises:
deleting, from the plurality of advertisement lists, a redundant advertisement list that has the same at least one associated audience group as that of a different one of the advertisement lists; and
incorporating advertisements in the redundant advertisement list into the different advertisement list.

9. The method of claim 7, wherein the step of refining comprises:
identifying a common audience group associated with more than one advertisement list comprising a redundant advertisement list and a different advertisement list;
determining whether the common audience group is a subset of the one or more audience groups associated with the redundant advertisement list; and
deleting the common audience group from the one or more audience groups associated with the redundant advertisement list, when the common audience group is a subset of the one or more audience groups associated with the redundant advertisement list and equals to that of the different advertisement list.

10. The method of claim 7, wherein the step of refining comprises:
identifying a common audience group associated with more than one advertisement list comprising a first and a second advertisement lists;
determining whether the common audience group is a subset of both the first and second advertisement lists; and
creating a third advertisement list with the common audience group as its associated audience group.

11. The method of claim 7, wherein the step of refining comprises creating a new advertisement list with an associated at least one audience group that is not associated with any of the plurality of advertisement lists.

12. The method of claim 1, wherein the at least one audience group to which the user belongs is determined further based on at least one of:
information related to a viewer source via which the online request is submitted by the user; and
a probability, determined based on a logistic regression model, related to a similarity in preference on similar advertisements between the user and other users in the at least one audience group.
